(19) United States
(12) Patent Application Publication
(10) Pub. No.: US 2025/0047414 A1
(43) Pub. Date: Feb. 6, 2025

(54) RADIO LINK CONTROL LAYER DATA RETRANSMISSION METHOD, APPARATUS, SYSTEM, AND STORAGE MEDIUM

(71) Applicant: Lenovo (Beijing) Limited, Beijing (CN)

(72) Inventor: Yao LU, Beijing (CN)

(21) Appl. No.: 18/790,775

(22) Filed: Jul. 31, 2024

(30) Foreign Application Priority Data
Jul. 31, 2023 (CN) 202310952881.6

(51) Int. Cl. H04L 1/00; H04L 1/1812

(52) U.S. Cl. CPC H04L 1/0073; H04L 1/1816

(57) ABSTRACT

A radio link control (RLC) layer data retransmission method includes: sending, by a first media access control (MAC) layer of a transmitting end, at least one code block group (CBG), each CBG including at least one data unit packet, and records index information of each corresponding data unit packet; within a timeslot period and before receiving feedback, receiving feedback information from a second MAC layer of a receiving end for each CBG; reporting, by the first MAC layer, the index information of each data unit packet corresponding to the CBG whose feedback information is negative to a first RLC layer of the transmitting end; and retransmitting, by the first RLC layer, the data unit packet whose feedback information is negative.

### CROSS-REFERENCE TO RELATED APPLICATION

This application claims priority to Chinese Patent Application No. 202310952881.6, filed on Jul. 31, 2023, and the entire content of which is incorporated herein by reference.

### TECHNICAL FIELD

The present disclosure relates to the technical field of wireless communication technology, and more particularly, to a method, an apparatus, a system, and a storage medium for retransmitting data at a radio link control layer.

### BACKGROUND

In 5G technology, radio link control (RLC) layer is located above media access control (MAC) layer, and mainly provides radio link control functions. In an acknowledge mode, RLC layer provides segmentation, retransmission, and other services to the upper layer. For example, after sending data to a receiving end, it is necessary to obtain a correct response signal or an error response signal (ACK/NACK) from the receiving end. RLC layer knows whether the receiving end has correctly received the data through ACK/NACK, to determine whether it is necessary to retransmit the data to the receiving end or send new data to the receiving end.

In traditional technology, the receiving end sends the error response signal NACK to a transmitting end to notify the transmitting end that RLC protocol data unit (PDU) has not been received and the retransmission function needs to be started. In order to reasonably utilize uplink resources, it is often necessary to send multiple error response signals NACK at MAC layer of the transmitting end before starting to feedback to RLC layer of the transmitting end. However, this solution does not meet real-time requirements of low-latency services to certain extent.

### SUMMARY

One aspect of the present disclosure provides a radio link control (RLC) layer data retransmission method. The method includes: sending, by a first media access control (MAC) layer of a transmitting end, at least one code block group (CBG), each CBG including at least one data unit packet, and records index information of each corresponding data unit packet; within a timeslot period and before receiving feedback, receiving feedback information from a second MAC layer of a receiving end for each CBG; reporting, by the first MAC layer, the index information of each data unit packet corresponding to the CBG whose feedback information is negative to a first RLC layer of the transmitting end; and retransmitting, by the first RLC layer, the data unit packet whose feedback information is negative.

Another aspect of the present disclosure provides a radio link control (RLC) layer data retransmission apparatus. The apparatus includes a memory storing program instructions and a processor coupled to the memory. When being executed by the processor, the program instructions cause the processor to: send at least one code block group (CBG) from a first media access control (MAC) layer of a transmitting end, each CBG including at least one data unit packet, and records index information of each corresponding data unit packet; within a timeslot period and before receiving feedback, receive feedback information from a second MAC layer of a receiving end for each CBG; report the index information of each data unit packet corresponding to the CBG whose feedback information is negative to a first RLC layer of the transmitting end; and retransmit the data unit packet whose feedback information is negative.

Another aspect of the present disclosure provides a computer-readable storage medium storing program instructions. When being executed by a processor, the program instructions cause the processor to perform a radio link control (RLC) layer data retransmission method. The method includes: sending, by a first media access control (MAC) layer of a transmitting end, at least one code block group (CBG), each CBG including at least one data unit packet, and records index information of each corresponding data unit packet; within a timeslot period and before receiving feedback, receiving feedback information from a second MAC layer of a receiving end for each CBG; reporting, by the first MAC layer, the index information of each data unit packet corresponding to the CBG whose feedback information is negative to a first RLC layer of the transmitting end; and retransmitting, by the first RLC layer, the data unit packet whose feedback information is negative.

### BRIEF DESCRIPTION OF THE DRAWINGS

To more clearly illustrate the technical solutions in the embodiments of the present disclosure, drawings required for the description of the embodiments are briefly described below. Obviously, the drawings described below are merely some embodiments of the present disclosure. For those skilled in the art, other drawings can be obtained based on these drawings without creative efforts.

FIG. 1 is a flowchart of a radio link control (RLC) layer data retransmission method according to some embodiments of the present disclosure;

FIG. 2 is a schematic diagram of a communication process between a transmitting end and a receiving end according to some embodiments of the present disclosure;

FIG. 3 is a flowchart of another RLC layer data retransmission method according to some embodiments of the present disclosure;

FIG. 4 is a schematic block diagram of an RLC layer data retransmission apparatus according to some embodiments of the present disclosure; and

FIG. 5 is a schematic block diagram of an RLC layer data retransmission system according to some embodiments of the present disclosure.

### DETAILED DESCRIPTION OF THE EMBODIMENTS

To enable those skilled in the art to better understand the technical solutions of the embodiments of the present disclosure, the technical solutions in the embodiments of the present disclosure will be clearly and completely described below in conjunction with the accompanying drawings. Obviously, the described embodiments are merely part of the embodiments of the present disclosure, not all of the embodiments. Based on the embodiments of the present disclosure, all other embodiments obtained by those skilled in the art without creative work are within the scope of the present disclosure.

In 5G protocol stack, RLC layer is located above MAC layer, and primarily provides RLC functions, and segmentation, retransmission, and other services for the upper layer. RLC layer at least supports two modes for service transmission: acknowledge mode (AM) and un-acknowledge mode (UM). AM mode provide services such as segmentation and retransmission. UM mode provides segmentation services. Generally, the retransmission service provided by RLC layer ensures the accuracy of the data to improve reliability of the data.

In traditional technology, the retransmission function in AM mode is triggered when negative feedback information NACK contained in control PDU of RLC layer is received at the receiving end. The feedback information NACK is used to notify the transmitting end that an RLC layer protocol data unit (The Core Protocol Data Unit, PDU) has not been received. To reasonably utilize uplink resources and avoid frequent transmission of control protocol data units by RLC layer at the receiving end, it is necessary to report the feedback information to RLC layer only after receiving multiple feedback NACKs of a code block group at MAC layer, and then trigger the control protocol data unit feedback of RLC layer. It can be seen that this method does not meet the real-time requirements of low-latency services to certain extent. The UM mode cannot guarantee the accuracy of the data because it does not have a retransmission function.

In response to the above problems, the present disclosure provides an RLC layer data retransmission method. The embodiment of the present disclosure adopts a cross-layer collaboration method. If MAC layer of the transmitting end receives 1-bit NACK feedback information from the code block group feedback from MAC layer of the receiving end, it means that the RLC PDU transmitted by the code block group cannot be correctly decoded in MAC layer, that is, RLC layer of the receiving end did not receive the correct RLC PDU at that time. At this time, MAC layer of the transmitting end can immediately report the RLC PDU information transmitted by the code block group to RLC layer of the transmitting end, so that RLC layer knows that these RLC PDUs have not been received by RLC layer of the receiving end, and can immediately add the RLC PDU to a retransmission list to wait for MAC layer to reschedule, without waiting for RLC layer of the receiving end to send a control PDU feedback NACK.

Based on at least one of the above technical problems, the present disclosure provides an RLC layer data retransmission method. The method includes the following process. The transmitting end sends at least one code block group at a first MAC layer. Each code block group includes at least one data unit packet, and each code block group records index information of each corresponding data unit packet. Within a timeslot period and before receiving feedback, feedback information is received from a second MAC layer of the receiving end for each code block group. The first MAC layer reports the index information of each data unit packet corresponding to the code block group for which the feedback information is negative information to the first RLC layer of the transmitting end. The first RLC layer performs retransmission processing on the data unit packet for which the feedback information is negative information. In the embodiments of the present disclosure, the RLC layer data retransmission method includes sending at least one code block group at the first MAC layer by the transmitting end, where each code block group records the index information of each corresponding data unit packet. Before receiving the feedback, when the second MAC layer of the receiving end receives the feedback information of each code block group, the first MAC layer reports the index information of each data unit packet corresponding to the received code block group to the first RLC layer. In this way, the data units that are not received correctly can be retransmitted faster, thereby improving efficiency of data transmission. At the same time, the accuracy of data transmission can also be guaranteed for the UM mode of the first RLC layer that does not have the retransmission capability.

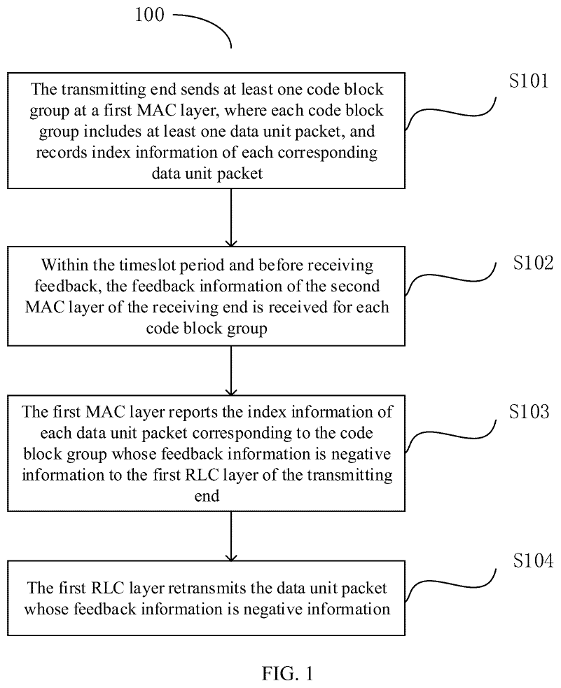

FIG. 1 is a flowchart of a radio link control (RLC) layer data retransmission method according to some embodiments of the present disclosure. As shown in FIG. 1, the method 100 for retransmitting data at a RLC layer includes the following processes.

At S101, the transmitting end sends at least one code block group at a first MAC layer, where each code block group includes at least one data unit packet, and records index information of each corresponding data unit packet.

Generally, in long term evolution (LTE), a larger transport block (TB) may be split into a string of smaller code blocks (CB). The entire TB is transmitted with a block error rate (BLER) target of 10%. If the BLER target is not met and cyclic redundancy check (CRC) fails, the entire TB must be retransmitted. However, sometimes performance of hybrid automatic repeat reQuest (HARQ) may be affected due to large TBs. Concepts of TB and CB also exist in 5G new radio (NR). To achieve high transmission efficiency and improve latency, 5G NR introduces a concept called code block group (CBG) based transmission, which basically divides large TBs into smaller CBs, and the smaller CBs are further grouped into CBGs. In 5G NR, one CBG often includes a plurality of CB groups. When a user equipment (UE) receives the CBG, the UE will decode the CBG and send HARQ feedback (ACK/NACK) for each individual CBG.

In addition, PDU is the basic unit in the communication protocol. It is the format for transmitting data between protocols at different levels. PDU contains data and control information to be transmitted, which can be transmitted to the receiving end through a network and then parsed and processed. In network communication, PDU is widely used. For example, in the process of sending and receiving short message service (SMS) messages, PDU is used to describe content and format of a SMS message. In network protocols, each protocol layer has its own PDU format.

Generally, a process of constructing PDU can be divided into the following steps.
1. Determining the data and control information to be transmitted.
2. According to the protocol, packaging the data and control information into a PDU format.
3. Sending the PDU to a receiver.
4. The receiver parses the PDU and processes the data and control information therein.

In some embodiments, the first RLC layer of the transmitting end constructs one or more first PDUs (i.e., RLC PDUs) and provides an index for each first PDU, and then transmits the one or more constructed first PDUs containing the respective index information to the first MAC layer. The first MAC layer schedules the one or more first PDUs sent by the first RLC layer, constructs the one or more first PDUs into one or more second PDUs (i.e., MAC PDUs), and then combines the one or more second PDUs into one or more CBGs for transmission. While transmitting, each CBG records the index value of each first PDU transmitted.

It is worth noting that when the first RLC layer constructs the first PDU, it is constructed based on a transport block size (TBSIZE) provided by the first MAC layer. In a 5G NR system, TBSIZE refers to a size of a data block that can be transmitted in each transmission time slot, which is an important indicator for measuring system efficiency. TBSIZE can be calculated as follows: TBSIZE={NPRB×NR×12×log2(MOD)}−{OH+G+RI}, where NPRB represents the number of resource blocks (RB), NR represents the number of symbols per RB, 12 is the number of bits per symbol, MOD represents the modulation mode (such as QPSK, 16QAM, 64QAM, etc.), OH represents protocol overhead, G represents a guard interval, and RI represents a cyclic prefix length.

It is worth noting that different modulation modes and guard intervals will affect TBSIZE, such that it needs to be adjusted according to system parameters during specific calculations. In addition, TBSIZE is also affected by other factors, such as channel quality, channel bandwidth, etc. Thus, TBSIZE provided by the first MAC layer is only a theoretical calculation result, which depends on actual transmission effect.

At S102, within the timeslot period and before receiving feedback, the feedback information of the second MAC layer of the receiving end is received for each code block group.

In conventional technology, the receiving end also includes a corresponding RLC layer and a MAC layer. Generally, when the second MAC layer of the receiving end receives one or more CBGs, it will pass the one or more CBGs upward to the second RLC layer of the receiving end. If the second RLC layer does not receive any CBG or a decoding error occurs, the second RLC layer will provide negative feedback information (i.e., NACK information) to the second MAC layer. The second MAC layer will send the NACK information to the first MAC layer of the transmitting end. The first MAC layer then reports the NACK information to the first RLC layer of the transmitting end. Moreover, the first MAC layer of the transmitting end will start reporting to the first RLC layer after receiving multiple NACK information. This increases the retransmission time.

The present disclosure is implemented in MAC layer, and a large TB in a multi-transmission time interval (TTI) scheduling may contain multiple RLC layer protocol data units (PDUs). The large TB may be mapped to multiple smaller code block groups (CBGs), so each code block group may contain one or more RLC layer protocol data units. Each code block group may use 1-bit HARQ feedback, that is, HARQ-ACK. When all CBs in a code block group are correctly decoded, 1-bit ACK related to the code block group is fed back. Otherwise, 1-bit NACK is fed back.

In CBG technology of the present disclosure, each time a CBG is sent, the receiving end may send corresponding ACK/NACK feedback information for the CBG. Thus, in the present disclosure, when the first MAC layer of the receiving end receives any CBG, feedback information may be sent for that CBG. The first MAC layer of the transmitting end may immediately report the feedback information to the first RLC layer of the transmitting end. The first RLC layer of the transmitting end may add the first PDU corresponding to any CBG to the retransmission queue for retransmission. It can be seen that the first RLC layer of the transmitting end does not need to wait for the feedback of the second RLC layer of the receiving end. Thus, the efficiency of retransmission is improved.

This solution adopts a cross-layer collaboration method. If the first MAC layer of the transmitting end receives 1-bit NACK information fed back by the CBG of the second MAC layer of the receiving end, it means that the RLC PDU transmitted by the CBG cannot be correctly decoded at the second MAC layer, that is, the second RLC layer of the receiving end may not receive the correct RLC PDU at that time.

At S103, the first MAC layer reports the index information of each data unit packet corresponding to the code block group whose feedback information is negative information to the first RLC layer of the transmitting end.

When the first MAC layer of the transmitting end receives the feedback information ACK/NACK of any CBG, the first PDU information in the group recorded by any CBG may be immediately reported to the first RLC layer of the transmitting end, such that the first RLC layer knows that the first PDU corresponding to the indexes is not received by the second LC layer of the receiving end R, and then the first PDUs may be retransmitted.

At S104, the first RLC layer retransmits the data unit packet whose feedback information is negative information.

In the embodiments of the present disclosure, after receiving the index information of the first PDU sent by the first MAC layer, the first RLC layer of the transmitting end immediately adds the first PDUs to the retransmission list and waits for the first MAC layer to reschedule, without waiting for the second RLC layer of the receiving end to send the control PDU feedback information NACK, thereby reducing the time of waiting for the second RLC layer of the receiving end to send the control PDU feedback information NACK.

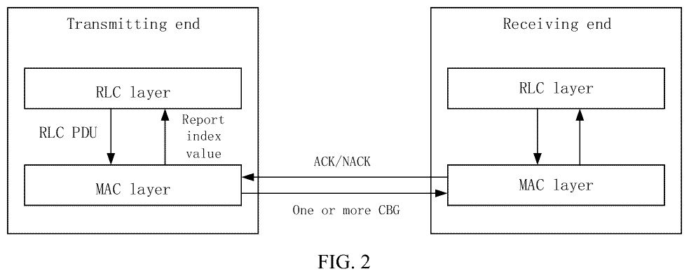

FIG. 2 is a schematic diagram of a communication process between a transmitting end and a receiving end according to some embodiments of the present disclosure. After RLC layer of the transmitting end constructs the RLC PDU, MAC layer may schedule the RLC PDU and construct one or more CBGs according to the RLC PDU and send them to MAC layer of the receiving end. After MAC layer decodes one or more CBGs, it feeds back information ACK/NACK to MAC layer of the receiving end. The transmitting end is unaware of data transmission between MAC layer and RLC layer of the receiving end. When MAC layer of the transmitting end receives the feedback information ACK/NACK of the CBG sent by MAC layer of the receiving end, and the feedback information is NACK, the index value of the RLC PDU corresponding to the CBG is reported to RLC layer, such that RLC layer resends the RLC PDU corresponding to the index value. The embodiment of the present disclosure only sends the CBG that failed to be transmitted, instead of sending the entire TB, which improves the efficiency of data transmission.

Compared with the traditional technology that must resend the entire TB once the decoding of TB fails, the technical solution of the present disclosure substantially improves the retransmission efficiency and accuracy. In particular, for large TBs (e.g., TBs containing many CBGs), the retransmission efficiency is significantly improved.

The present disclosure adopts a CBG-based HARQ scheme for data retransmission. For example, the transmitting end may send a TB divided into several CBGs. The receiving end may decode each CBG separately and provide HARQ-ACK feedback for each CBG. Based on the CBG-level HARQ-ACK feedback, the transmitting end may retransmit only the CBG that is negatively acknowledged instead of retransmitting the entire TB. In this way, when transmitting data, especially for large TBs, data retransmission can be more efficient.

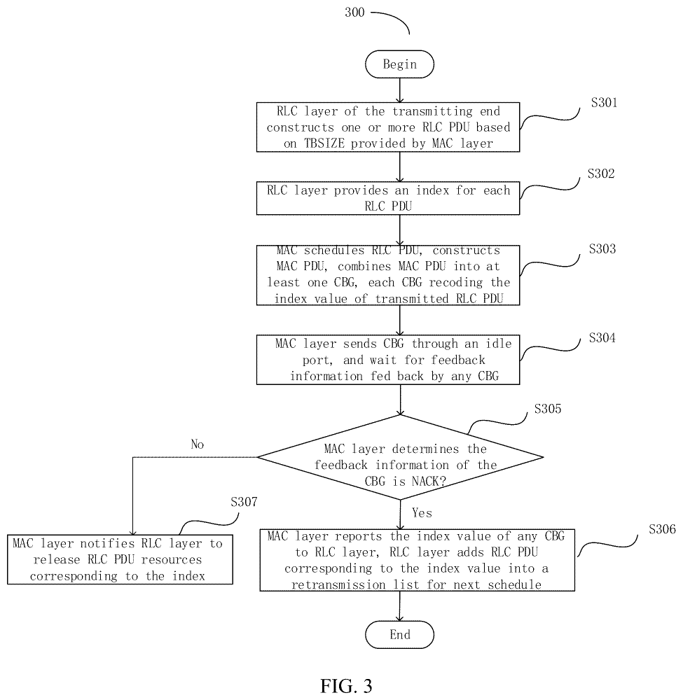

FIG. 3 is a flowchart of another RLC layer data retransmission method 300 according to some embodiments of the present disclosure. As shown in FIG. 3, the RLC layer data retransmission method 300 includes the following processes S301-S307.

At S301, RLC layer of the transmitting end constructs one or more RLC PDUs according to TBSIZE provided by MAC layer.

RLC layer of the transmitting end constructs one or more RLC PDUs according to TBSIZE provided by MAC layer, such that MAC layer can schedule the one or more RLC PDUs.

At S302, RLC layer provides an index for each RLC PDU.

RLC layer itself provides an index value for each RLC PDU, records the index value of each RLC PDU, and then notifies MAC layer. The index value is provided for each RLC PDU such that RLC layer and MAC layer can determine the RLC PDU according to the index value when transmitting data, instead of transmitting the RLC PDU, which reduces the amount of data transmission between layers and save resources.

At S303, MAC layer schedules the RLC PDU and constructs the MAC PDU, and then organizes the MAC PDU into at least one CBG, and each CBG records the index value of each transmitted RLC PDU.

When MAC layer of the transmitting end constructs at least one CBG, the at least one CBG records the index value of each transmitted RLC PDU, such that when the feedback information NACK is received, the index value of the corresponding RLC PDU is reported.

At S304, MAC layer sends the at least one CBG through an air interface and waits for the feedback information returned by any uplink CBG.

MAC layer receives the feedback information of all downlink CBGs in the timeslot period in the uplink timeslot. The feedback information of the downlink CBGs does not arrive at the same time. Any CBG may arrive. Thus, when MAC layer receives the feedback information NACK of any CBG, it will report the index value of the RLC PDU corresponding to any CBG.

At S305, MAC layer determines whether the feedback information of any CBG is NACK. If so, S306 is executed. Otherwise, S307 is executed.

When MAC layer receives any CBG feedback information, it will determine whether the feedback information is NACK. If the feedback information of any CBG is NACK, the index value of the RLC PDU transmitted by any CBG is searched to facilitate reporting to RLC layer.

At S306, MAC layer reports the index value saved by any CBG to RLC layer, and RLC layer adds the RLC PDU corresponding to the index value to the retransmission list and waits for the next scheduling.

MAC layer of the transmitting end may report the index value of the RLC PDU directly to RLC layer according to the index value of each RLC PDU in the group recorded by the CBG, such that RLC layer can add the RLC PDU corresponding to the index value to the retransmission list and wait for retransmission.

At S307, MAC layer notifies RLC layer to release the RLC PDU resources corresponding to the index value.

In the embodiment of the present disclosure, after RLC layer releases the RLC PDU resources of the corresponding index value, the TB resources occupied by the control PDU will be reduced.

The present disclosure provides a CBG-based RLC PDU fast retransmission method through cross-layer collaboration. RLC layer only needs to obtain the RLC PDU information transmitted by the CBG that receives NACK to retransmit these PDUs. For AM mode, the method improves the efficiency of retransmission without waiting for the control PDU feedback from the receiving end. For UM mode, the method improves the accuracy of data transmission.

Then, combined with the feedback of CBG, the RLC PDUs that are confirmed to be unable to be correctly received by the receiving end can be retransmitted quickly by RLC layer. If the retransmitted RLC PDU reaches RLC layer of the receiving end before RLC layer of the receiving end sends the control PDU of NACK, the TB resources occupied by the control PDU will be reduced. At the same time, the accuracy of data transmission can also be guaranteed for UM mode that does not have the retransmission capability in the protocol.

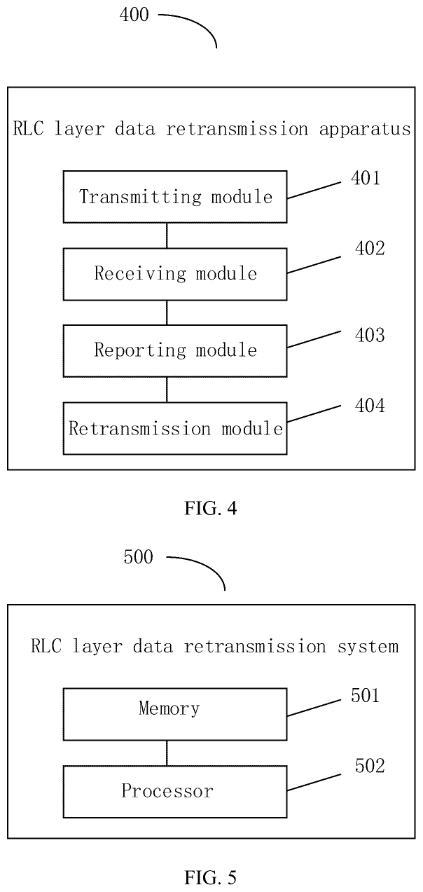

The present disclosure also provides an RLC layer data retransmission apparatus. FIG. 4 is a schematic block diagram of an RLC layer data retransmission apparatus 400 according to some embodiments of the present disclosure. As shown in FIG. 4, the RLC layer data retransmission apparatus 400 includes a transmitting module 401, a receiving module 402, a reporting module 403, and a retransmission module 404.

The transmitting module 401 is used for the transmitting end to send at least one code block group at the first MAC layer, where each code block group includes at least one data unit packet, and records the index information of each corresponding data unit packet.

PDU is the basic unit in the communication protocol, which is the format for transmitting data between different protocol layers. PDU contains the data and control information to be transmitted, which can be transmitted to the receiving end through the network and then parsed and processed. In network communication, PDU is widely used. For example, in the process of sending and receiving SMS messages, PDU is used to describe the content and format of SMS messages. In the network protocol, each protocol layer has its own PDU format.

Generally, the process of constructing a PDU can be divided into the following steps: 1. determining the data and control information to be transmitted; 2. according to the protocol, packaging the data and control information into a PDU format; 3. sending PDU to the receiving end; and 4. at the receiving end, parsing PDU and processing the data and control information therein.

For the transmitting end, RLC layer of the transmitting end constructs one or more first PDUs (i.e., RLC PDUs) and provides an index for each first PDU, and then transmits the one or more constructed first PDUs containing the respective index information to MAC layer. MAC layer schedules the one or more first PDUs sent by RLC, constructs the one or more first PDUs into one or more second PDUs (i.e., MAC PDUs), and then combines the one or more second PDUs into one or more CBGs for transmission. While transmitting, each CBG records the index value of each first PDU transmitted.

It is worth noting that when RLC layer constructs the one or more first PDU, they are constructed according to the transport block size (i.e., TBSIZE) provided by MAC layer. In 5G NR system, TBSIZE refers to the size of the data block that can be transmitted in each transmission timeslot, which is an important indicator for measuring system efficiency. TBSIZE can be calculated as follows: TBSIZE={NPRB×NR×12×log2(MOD)}−{OH+G+RI}, where NPRB represents the number of resource blocks (RB), NR represents the number of symbols per RB, 12 represents the number of bits per symbol, MOD represents the modulation mode (such as QPSK, 16QAM, 64QAM, etc.), OH represents the protocol overhead, G represents the guard interval, and RI represents the cyclic prefix length.

It is worth noting that different modulation modes and guard intervals will affect TBSIZE, so it needs to be adjusted according to system parameters during specific calculations. In addition, TBSIZE is also affected by other factors, such as channel quality, channel bandwidth, etc. Thus, TBSIZE provided by MAC layer is only a theoretical calculation result, which depends on the actual transmission effect.

The receiving module 402 is used to receive the feedback information of the second MAC layer of the receiving end for each code block group within the timeslot period and before the second RLC layer of the receiving end sends feedback.

In the CBG technology of the present disclosure, each time a CBG is sent, the receiving end will send corresponding ACK/NACK feedback information for the CBG. Thus, in the present disclosure, when MAC layer of the receiving end receives any CBG, it will send feedback information for that CBG. MAC layer of the transmitting end will immediately report the feedback information to RLC layer of the transmitting end. RLC layer of the transmitting end will add the first PDU corresponding to that CBG to the retransmission queue for retransmission. It can be seen that RLC layer of the transmitting end does not need to wait for the feedback of RLC layer of the receiving end. Therefore, the efficiency of retransmission is improved.

The above scheme adopts a cross-layer collaboration method. If MAC layer of the transmitting end receives 1-bit NACK information fed back by the CBG of MAC layer of the receiving end, it means that the RLC PDU transmitted by the CBG cannot be correctly decoded at MAC layer, that is, RLC layer of the receiving end does not receive the correct RLC PDU at that time.

The reporting module 403 is used for the first MAC layer to report the index information of each data unit packet corresponding to the code block group whose feedback information is negative to the first RLC layer of the transmitting end.

When MAC layer of the transmitting end receives the feedback information ACK/NACK of any CBG, the first PDU information in the group recorded by that CBG may be immediately reported to RLC layer of the transmitting end, such that RLC layer knows that the first PDUs corresponding to certain indexes have not been received by RLC layer of the receiving end, and then the first PDUs can be retransmitted.

The retransmission module 404 is used for the first RLC layer to retransmit the data unit packet whose feedback information is negative.

In the embodiments of the present disclosure, after receiving the index information of the first PDUs sent by MAC layer, RLC layer of the transmitting end immediately adds these first PDUs to the retransmission list and waits for MAC layer to reschedule, without waiting for RLC layer of the receiving end to send the control PDU feedback information NACK, thereby reducing the time of waiting for RLC layer of the receiving end to send the control PDU feedback information NACK.

The present disclosure also provides an RLC layer data retransmission system. FIG. 5 is a schematic block diagram of an RLC layer data retransmission system 500 according to some embodiments of the present disclosure.

As shown in FIG. 5, the RLC layer data retransmission system 500 includes: a memory 501 and a processor 502, where the memory 501 stores a computer program executed by the processor 502, and when the computer program is executed by the processor 502, the processor 502 performs the RLC layer data retransmission method described above.

The RLC layer data retransmission system 500 may be part or all of a computer device that implements the RLC layer data retransmission method by software, hardware, or a combination thereof.

As shown in FIG. 5, the RLC layer data retransmission system 500 includes one or more memories 501, one or more processors 502, a display (not shown), and a communication interface (not shown), etc. These components are interconnected through a bus system and/or other forms of connection mechanisms (not shown). It should be noted that the components and structures of the RLC layer data retransmission system 500 shown in FIG. 5 are exemplary only, and not restrictive. The RLC layer data retransmission system 500 may also have other components and structures as needed.

The memory 501 is used to store various data generated during the operation of the method and executable program instructions, such as for storing various applications or algorithms for implementing various specific functions. It may include one or more computer program products, which may include various forms of computer-readable storage media, such as volatile memory and/or non-volatile memory. The volatile memory may include, for example, random access memory (RAM) and/or cache memory (cache), etc. The non-volatile memory may include, for example, read-only memory (ROM), hard disk, flash memory, etc.

The processor 502 may be a central processing unit (CPU), a graphics processing unit (GPU), an application-specific integrated circuit (ASIC), a field programmable gate array (FPGA), or other forms of processing units with data processing capabilities and/or instruction execution capabilities, and may be other components in the RLC layer data retransmission system 500 to perform the desired functions.

In one example, the RLC layer data retransmission system 500 also includes an output device that outputs various information (such as images or sounds) to the outside (such as a user), and may include one or more display devices and speakers, etc.

The communication interface is an interface of any currently known communication protocol, such as a wired interface or a wireless interface. The communication interface may include one or more serial ports, USB interfaces, Ethernet ports, WiFi, wired networks, DVI interfaces, device integrated interconnection modules or other suitable ports, interfaces, or connections.

In addition, the present disclosure also provides a storage medium on which program instructions are stored. When the program instructions are executed by a computer or a processor, the corresponding steps of the RLC layer data retransmission method of the embodiments of the present disclosure are performed. The storage medium may include, for example, a memory card of a smart phone, a storage component of a tablet computer, a hard disk of a personal computer, a read-only memory (ROM), an erasable programmable read-only memory (EPROM), a portable compact disk read-only memory (CD-ROM), a USB memory, or any combination of the above storage media.

The RLC layer data retransmission device, system and storage medium of the embodiments of the present disclosure have the same advantages as the RLC layer data retransmission method because they can implement the RLC layer data retransmission method.

Although various embodiments have been described herein with reference to the accompanying drawings, it should be understood that the above embodiments are merely illustrative and are not intended to limit the scope of the present disclosure. A person of ordinary skill in the art may make various changes and modifications therein without departing from the scope and spirit of the present disclosure. All such changes and modifications are intended to be included within the scope of the present disclosure as required by the appended claims.

A person of ordinary skill in the art may realize that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of the present disclosure.

In the embodiments of the present disclosure, it should be understood that the disclosed devices and methods can be implemented in other ways. For example, the device embodiments described above are merely schematic, for example, the division of the units is only a logical function division, and there may be other division methods in actual implementation, such as multiple units or components can be combined or integrated into another device, or some features can be ignored or not executed.

In the description provided herein, a large number of specific details are described. However, it is understood that embodiments of the present disclosure can be practiced without these specific details. In some instances, well-known methods, structures, and techniques are not shown in detail so as not to obscure the understanding of the present disclosure.

Similarly, it should be understood that to streamline the present disclosure and help understand one or more of the various inventive aspects, in the description of the exemplary embodiments of the present disclosure, the various features of the present disclosure are sometimes grouped together into a single embodiment, figure, or description thereof. However, the method of the present disclosure should not be interpreted as reflecting the following intention: the claimed invention requires more features than the features explicitly stated in each claim. More precisely, as reflected in the corresponding claims, the inventive point is that the corresponding technical problem can be solved with less than all the features of a single disclosed embodiment. Therefore, the claims following the specific embodiment are hereby expressly incorporated into the specific embodiment, where each claim itself is a separate embodiment of the present disclosure.

It should be understood by those skilled in the art that, except for mutually exclusive features, all features disclosed in the specification (including the accompanying claims, abstracts and drawings) and all processes or units of any method or device disclosed in the specification can be combined in any combination. Unless otherwise explicitly stated, each feature disclosed in the specification (including the accompanying claims, abstracts and drawings) can be replaced by an alternative feature that provides the same, equivalent or similar purpose.

In addition, it should be understood by those skilled in the art that although some embodiments described herein include certain features included in other embodiments but not other features, the combination of features of different embodiments is meant to be within the scope of the present disclosure and form different embodiments. For example, in the claims, any one of the claimed embodiments can be used in any combination.

The various component embodiments of the present disclosure can be implemented in hardware, or in software modules running on one or more processors, or in a combination thereof. It should be understood by those skilled in the art that a microprocessor or a digital signal processor (DSP) can be used in practice to implement some or all of the functions of some modules according to the embodiments of the present disclosure. The present disclosure can also be implemented as a device program (e.g., a computer program and a computer program product) for executing part or all of the methods described herein. Such a program for implementing the present disclosure may be stored on a computer-readable medium, or may be in the form of one or more signals. Such a signal may be downloaded from an Internet website, or provided on a carrier signal, or provided in any other form.

It should be noted that the above embodiments illustrate rather than limit the present disclosure, and that an ordinary person skilled in the art may devise alternative embodiments without departing from the scope of the appended claims. In the claims, any reference symbol between parentheses shall not be construed as a limitation on the claims. The word “comprising” does not exclude the presence of elements or steps not listed in the claims. The word “one” or “an” preceding an element does not exclude the presence of a plurality of such elements. The present disclosure may be implemented by means of hardware comprising several different elements and by means of a suitably programmed computer. In a unit claim enumerating several means, several of these means may be embodied by the same hardware item. The use of the words first, second, and third, etc. does not indicate any order. These words may be interpreted as names or labels.

The above is only a specific implementation or description of a specific implementation of the present disclosure, and the protection scope of the present disclosure is not limited thereto. Those skilled in the art can easily think of changes or substitutions within the technical scope disclosed in the present disclosure, which should be included in the protection scope of the present disclosure. The protection scope of the present disclosure shall be based on the protection scope of the claims.

What is claimed is:

1. A radio link control (RLC) layer data retransmission method, comprising:
sending, by a first media access control (MAC) layer of a transmitting end, at least one code block group (CBG), each CBG including at least one data unit packet, and records index information of each corresponding data unit packet;
within a timeslot period and before receiving feedback, receiving feedback information from a second MAC layer of a receiving end for each CBG;
reporting, by the first MAC layer, the index information of each data unit packet corresponding to the CBG whose feedback information is negative to a first RLC layer of the transmitting end; and
retransmitting, by the first RLC layer, the data unit packet whose feedback information is negative.

2. The method according to claim 1, wherein each CBG corresponds to one feedback information, the method further comprising:
in response to receiving the feedback information sent by the second MAC layer, reporting, by the first MAC layer, the feedback information to the first RLC layer;
determining, by the first RLC layer, whether the feedback information is negative; and
in response to the feedback information being negative, adding, by the first RLC, the data unit corresponding to the feedback information to a retransmission list.

3. The method according to claim 2, further comprising:
in response to the feedback information being not negative, releasing, by the first RLC layer, resources of the data unit corresponding to the feedback information.

4. The method according to claim 1, further comprising:
constructing, by the first RLC layer, at least one data unit packet according to a unit packet size provided by the first MAC layer;
providing, by the first RLC layer, the index information for each of the at least one data unit packet; and
sending, by the first RLC layer, the at least one data unit packet with the index information to the first MAC layer, so that the first MAC layer combines the at least one data unit packet into a CBG for transmission.

5. The method according to claim 1, further comprising:
packaging, by the first MAC layer, the at least one data unit packet into at least one MAC layer data unit;
combining, by the first MAC layer, the at least one MAC layer data unit into at least one CBG; and
sending the at least one CBG to the receiving end through an idle port.

6. The method according to claim 1, wherein:
when the first MAC layer combines the at least one MAC layer data unit into the at least one CBG, each of the at least one CBG records the index information corresponding to each data unit packet in the at least one MAC layer data unit.

7. The method according to claim 1, wherein:
when the first MAC layer receives the feedback information corresponding to each CBG of the receiving end, the first MAC layer reports the index information of each data unit packet in each CBG to the first RLC layer; and
the first RLC layer adds the corresponding data unit packet to a retransmission queue according to the index information of each data unit packet in each CBG to wait for next scheduled retransmission.

8. A radio link control (RLC) layer data retransmission apparatus, comprising a memory storing program instructions and a processor coupled to the memory, when being executed by the processor, the program instructions cause the processor to:
send at least one code block group (CBG) from a first media access control (MAC) layer of a transmitting end, each CBG including at least one data unit packet, and records index information of each corresponding data unit packet;
within a timeslot period and before receiving feedback, receive feedback information from a second MAC layer of a receiving end for each CBG;
report the index information of each data unit packet corresponding to the CBG whose feedback information is negative to a first RLC layer of the transmitting end; and
retransmit the data unit packet whose feedback information is negative.

9. The apparatus according to claim 8, wherein each CBG corresponds to one feedback information, the processor is further configured to:
in response to receiving the feedback information sent by the second MAC layer, report the feedback information from the first MAC layer to the first RLC layer;
determine, at the first RLC layer, whether the feedback information is negative; and
in response to the feedback information being negative, add, at the first RLC, the data unit corresponding to the feedback information to a retransmission list.

10. The apparatus according to claim 9, wherein the processor is further configured to:
in response to the feedback information being not negative, release, at the first RLC layer, resources of the data unit corresponding to the feedback information.

11. The apparatus according to claim 8, wherein the processor is further configured to:
construct, at the first RLC layer, at least one data unit packet according to a unit packet size provided by the first MAC layer;
provide, at the first RLC layer, the index information for each of the at least one data unit packet; and
send, at the first RLC layer, the at least one data unit packet with the index information to the first MAC layer, so that the first MAC layer combines the at least one data unit packet into a CBG for transmission.

12. The apparatus according to claim 8, wherein the processor is further configured to:
package, at the first MAC layer, the at least one data unit packet into at least one MAC layer data unit;
combine, at the first MAC layer, the at least one MAC layer data unit into at least one CBG; and
send the at least one CBG to the receiving end through an idle port.

13. The apparatus according to claim 8, wherein:
when the first MAC layer combines the at least one MAC layer data unit into the at least one CBG, each of the at least one CBG records the index information corresponding to each data unit packet in the at least one MAC layer data unit.

14. The apparatus according to claim 8, wherein:
when the first MAC layer receives the feedback information corresponding to each CBG of the receiving end, the first MAC layer reports the index information of each data unit packet in each CBG to the first RLC layer; and
the first RLC layer adds the corresponding data unit packet to a retransmission queue according to the index information of each data unit packet in each CBG to wait for next scheduled retransmission.

15. A computer-readable storage medium storing program instructions, when being executed by a processor, the program instructions cause the processor to perform a radio link control (RLC) layer data retransmission method, the method comprising:
sending, by a first media access control (MAC) layer of a transmitting end, at least one code block group (CBG), each CBG including at least one data unit packet, and records index information of each corresponding data unit packet;
within a timeslot period and before receiving feedback, receiving feedback information from a second MAC layer of a receiving end for each CBG;
reporting, by the first MAC layer, the index information of each data unit packet corresponding to the CBG whose feedback information is negative to a first RLC layer of the transmitting end; and
retransmitting, by the first RLC layer, the data unit packet whose feedback information is negative.

16. The storage medium according to claim 15, wherein each CBG corresponds to one feedback information, the method further comprising:
in response to receiving the feedback information sent by the second MAC layer, reporting, by the first MAC layer, the feedback information to the first RLC layer;
determining, by the first RLC layer, whether the feedback information is negative; and
in response to the feedback information being negative, adding, by the first RLC, the data unit corresponding to the feedback information to a retransmission list.

17. The storage medium according to claim 16, the method further comprising:
in response to the feedback information being not negative, releasing, by the first RLC layer, resources of the data unit corresponding to the feedback information.

18. The storage medium according to claim 15, the method further comprising:
constructing, by the first RLC layer, at least one data unit packet according to a unit packet size provided by the first MAC layer;
providing, by the first RLC layer, the index information for each of the at least one data unit packet; and
sending, by the first RLC layer, the at least one data unit packet with the index information to the first MAC layer, so that the first MAC layer combines the at least one data unit packet into a CBG for transmission.

19. The storage medium according to claim 15, the method further comprising:
packaging, by the first MAC layer, the at least one data unit packet into at least one MAC layer data unit;
combining, by the first MAC layer, the at least one MAC layer data unit into at least one CBG; and
sending the at least one CBG to the receiving end through an idle port.

20. The storage medium according to claim 15, wherein:
when the first MAC layer combines the at least one MAC layer data unit into the at least one CBG, each of the at least one CBG records the index information corresponding to each data unit packet in the at least one MAC layer data unit.
